(19) United States
(12) Patent Application Publication
(10) Pub. No.: US 2017/0019731 A1
(43) Pub. Date: Jan. 19, 2017

(54) MONOLITHIC CERAMIC TRANSDUCERS WITH EMBEDDED ELECTRODES

(71) Applicant: LOCKHEED MARTIN CORPORATION, Bethesda, MD (US)

(72) Inventors: Kevin H. WILSON, Baldwinsville, NY (US); Walter CHYRYWATY, III, Red Creek, NY (US); James D. WEIGNER, Clay, NY (US)

(21) Appl. No.: 15/210,038

(22) Filed: Jul. 14, 2016

Related U.S. Application Data
(60) Provisional application No. 62/192,156, filed on Jul. 14, 2015.

(51) Int. Cl. H04R 1/44; G01V 1/02; G01V 1/18

(52) U.S. Cl. CPC H04R 1/44; G01V 1/186; G01V 1/02

(57) ABSTRACT

Transducers and processes of forming the transducers are described. The transducers are produced as a monolithic body of a ceramic material and electrodes embedded in and encased by the ceramic material, with the ceramic material and the electrodes being co-fired to produce the monolithic body. By embedding the electrodes in the ceramic material, the ceramic material protects the electrodes and isolates the electrodes from the environment, eliminating or reducing the need for separate sealing or potting material to isolate the electrodes from the surrounding environment. In addition, unique transducer designs can be produced, and the electrodes can have configurations and can be located in the transducer in locations that are not possible with traditional transducer production techniques.

### FIELD

This technical disclosure relates to ceramic transducers that are usable in any applications that use transducers including, but not limited to, microphones such as hydrophones and acoustic projectors such as underwater acoustic projectors.

### BACKGROUND

In current ceramic transducer designs, electrodes of the transducer that are exposed to the environment can be degraded over time if not protected, and the performance of the transducer can be degraded or the electrodes can be electrically shorted by the environment.

It is known to encapsulate the electrodes or the transducer as a whole with an encapsulant, separate from the ceramic material forming the transducer body, to protect the electrodes from the surrounding environment. However, the long term performance of the encapsulant can be problematic since the encapsulant can break down over time or the material properties of the encapsulant can be altered by the environment.

In addition, traditional transducer production methods have involved significant processing, including machining steps, to place the electrodes. However, machining of certain materials, such as lead zirconate titanate (PZT), can free potentially hazardous materials such as lead and is therefore environmentally unfriendly. Further, the placement of the electrodes in the transducer is limited using traditional production methods. In addition, traditional electrode configurations and the associated mechanical assembly of these configurations lead to mechanical inefficiencies in the final transducer.

### SUMMARY

Transducers and a process of forming the transducers are described herein. The transducers are produced as a monolithic body of a ceramic material and electrodes embedded in the ceramic material, with the ceramic material and the electrodes being co-fired to produce the monolithic body. By embedding the electrodes in the ceramic material, the ceramic material protects the electrodes and isolates the electrodes from the environment, eliminating or reducing the need for separate sealing or potting material to isolate the electrodes from the surrounding environment. In addition, unique transducer designs can be produced, and the electrodes can have configurations and locations in the transducer that are not possible with traditional transducer production techniques.

The transducers described herein can be used in any environments, and in any applications, in which transducers are or can be used. One example application is in underwater environments, for example in hydrophones and underwater acoustic projectors, where the transducer is exposed to water such as salt water. Since the electrodes are embedded in the ceramic material, the ceramic material protects the electrodes from the degrading effects of the water without requiring separate sealing or potting material to isolate the electrodes from the water.

In one embodiment, a monolithic transducer comprises a monolithic body formed from a ceramic material and at least one electrode embedded in and substantially encased in the ceramic material. In one embodiment, no surface of the at least one electrode is exposed to a surrounding environment. In another embodiment, a small section of the at least one electrode can be exposed to the surrounding environment to provide for electrical connection to the electrode, with the remainder of the electrode surrounded by the ceramic material.

The electrodes can be completely embedded in the ceramic material with some portion of each electrode made accessible through the ceramic material for electrical connection. In some embodiments, some of the electrodes can be completely embedded in the ceramic material, while other electrodes can be made accessible through the ceramic material for electrical connection. An electrode can be made accessible in any manner allowing electrical connection to the electrode. For example, some portion of the electrode can be left uncovered by the ceramic material, one or more wires can be embedded in the transducer extending from the electrode and through the ceramic material, or one or more vias can be created through the ceramic material that connect to the electrode. Electrical connection can also be established by capacitive coupling or inductive coupling in which case the entirety of each electrode can be encased in the ceramic material with no portions of the electrodes physically exposed outside the ceramic material. Other forms of electrical connection are possible.

In one embodiment, a process of forming a monolithic transducer includes embedding at least one electrode in an un-fired ceramic material. The un-fired ceramic material and the at least one electrode are then co-fired to produce a monolithic body. By locating the electrodes in the un-fired ceramic material, and then co-firing the un-fired ceramic material and the electrodes together, complex electrode design and placement can be achieved, and the amount of complex and expensive post machining of the monolithic body is reduced or eliminated.

### DRAWINGS

FIG. 1 is a flow chart of a process of producing a transducer described herein.

FIG. 2 illustrates an embodiment of a transducer described herein in the form of a plate with linear electrodes.

FIG. 3 illustrates an embodiment of a transducer described herein in the form of a disk with circumferential electrodes.

FIG. 4 illustrates an embodiment of a transducer described herein in the form of a cylinder with circumferential electrodes.

FIG. 5 illustrates an embodiment of a transducer described herein in the form of a ring with axial/radial electrodes.

### DETAILED DESCRIPTION

The term monolithic transducer as used herein including the claims, unless otherwise indicated, is intended to mean a transducer that is a single-piece, integrally formed body of ceramic material and one or more electrodes that are substantially embedded or encased in the ceramic material. Because the electrodes are embedded in the ceramic material, the electrodes cannot be removed from the ceramic without machining or destroying the ceramic material.

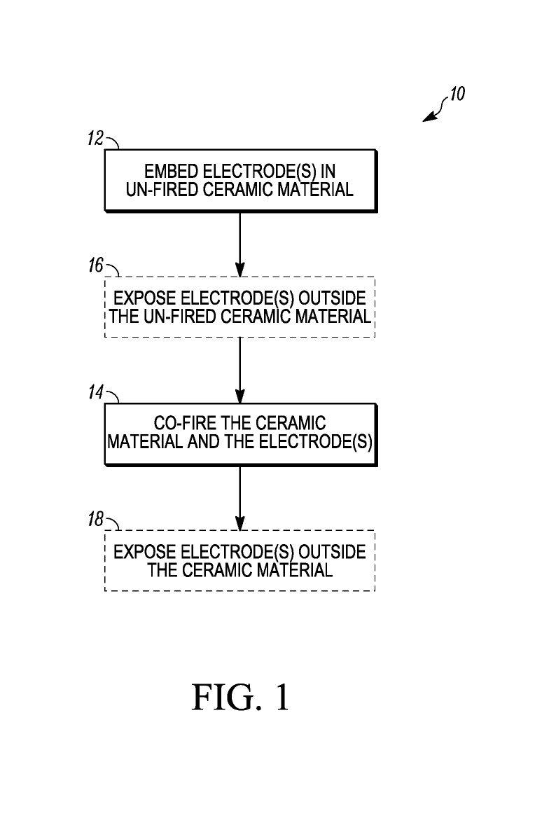

Referring to FIG. 1, a process 10 of forming a monolithic transducer described herein is illustrated. In the process 10, one or more electrodes are initially embedded in un-fired ceramic material as indicated at 12. The electrodes described herein can be any material that can conduct electricity and that can be co-fired during the ceramic sintering process to become integral with the fired ceramic. Examples of electrode materials that can be used include, but are not limited to, silver, palladium, platinum and combinations thereof. The ceramic material can be any ceramic material suitable for forming a transducer including, but not limited to, PZT.

One suitable technique for embedding the electrodes in the ceramic material is to use additive manufacturing. One non-limiting example of additive manufacturing that could be used is three-dimensional printing. The use of three-dimensional printing to produce ceramic objects is known from Robocasting Enterprises LLC of Albuquerque, N. Mex. In the case of a three-dimensional printing form of additive manufacturing of the transducer described herein, the ceramic material can be printed layer-by-layer. At the locations of the electrodes, a different, electrically conductive material can be printed to form the electrodes. The electrodes are then covered by one or more additional layers of the ceramic material. However, other types of additive manufacturing techniques can be used as long as the ceramic material and the electrodes are fired together and the resulting transducer is a monolithic body.

After the electrodes are embedded in the ceramic material at the desired locations, the un-fired ceramic material and the electrodes are co-fired together at 14 to produce a monolithic transducer body. Co-firing as used herein means that the un-fired ceramic material and the electrodes are fired in a kiln (or the ceramic material is otherwise cured) at the same time.

Prior to co-firing 14, an optional step 16 can be performed where the electrodes are exposed outside the un-fired ceramic material to permit electrical connection to the electrodes. Exposed outside the un-fired ceramic material is intended to encompass any means that permits establishment of an electrical connection with the electrodes of the transducer. For example, a portion of an electrode can be left uncovered by the ceramic material to expose that uncovered portion of the electrode for electrical connection. In another example, an electrode can be configured to extend to an end of the transducer body so that at least an end surface of the electrode is uncovered by the ceramic material so that the end surface is accessible for electrical connection. In another example, a via that is formed by electrically conductive material, which can be the same as or different than the electrically conductive material forming the electrode, can be produced during the additive manufacturing process. The via can extend from the electrode to any point on the exterior surface of the ceramic material so that the via permits electrical connection to the electrode. In still another example, a wire can be attached to the electrode and extended outside of the ceramic material for electrical connection to the electrode. The wire can be formed by additive manufacturing and/or placed during the additive manufacturing process, or the wire can be attached to the electrode after the electrode is embedded in the ceramic material. Combinations of these techniques can be utilized as well.

Alternatively or additionally to the optional step 16, after co-firing 14, an optional step 18 can be performed where the electrodes are exposed outside the fired ceramic material to permit electrical connection to the electrodes. Exposed outside the fired ceramic material is intended to encompass any means that permits establishment of an electrical connection with the electrodes after the ceramic material has been fired. For example, the ceramic material can be machined in order to remove some of the ceramic material and expose a portion of an electrode embedded therein to permit electrical connection using a wire or by creating an electrical via where the now removed ceramic material once resided.

Exposed outside the ceramic material, whether fired or un-fired, is also intended to encompass capacitive coupling and inductive coupling as means of establishing an electrical connection with the electrodes. In such embodiments, since direct electrical connection is not required, the electrodes can be completely embedded within the ceramic material with no portion of the electrodes physically exposed outside the ceramic material.

Once the monolithic transducer is produced, the transducer can be incorporated into a desired application. For example, the monolithic transducer can be incorporated into an active transducer device such as a microphone, for example a hydrophone. In another example, the monolithic transducer can be incorporated into an active acoustic projector, for example an underwater acoustic projector. In a hydrophone and an underwater acoustic projector, the transducer is exposed to the water, such as salt water. However, the ceramic material in which the electrodes are embedded protects the electrodes from the degrading effects of the water, eliminating or significantly reducing the need for a sealant or potting material, separate from the ceramic material, to protect the electrodes.

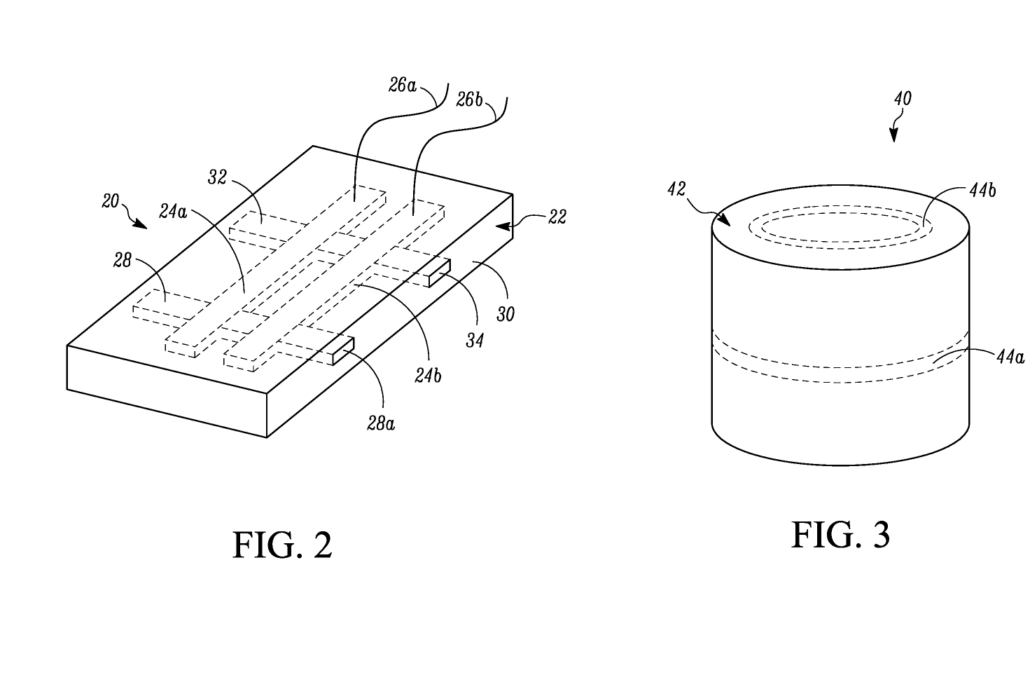

The process described herein permits the creation of unique transducer designs, including electrode locations and configurations, that are not possible with traditional transducer production techniques. For example, FIG. 2 illustrates a plate-shaped transducer 20 that comprises a monolithic body 22 formed by the process described above. The monolithic body 22 is formed by a ceramic material, and at least one electrode (shown in broken lines) is embedded in and substantially encased by the ceramic material. This example illustrates two linear electrodes 24a, 24b completely embedded within the ceramic material and extending generally parallel to one another. Each electrode 24a, 24b is completely and entirely encased within the ceramic material so that no portion of either electrode 24a, 24b is directly physically exposed to the surrounding environment. Instead, either prior to co-firing or after co-firing, wires 26a, 26b are attached to the respective electrodes 24a, 24b and extended through the ceramic material to provide electrical connection.

FIG. 2 shows an alternative configuration where a linear electrode 28 is illustrated in broken lines indicating that the electrode 28 is embedded in the ceramic material. However, an end 28a of the electrode 28 extends to and is exposed at a surface 30 of the monolithic body to permit electrical connection directly to the end 28a of the electrode 28. Therefore, other than the end 28a, the remainder of the electrode 28 is encased within the ceramic material.

FIG. 2 shows still another alternative configuration where a linear electrode 32 is illustrated in broken lines indicating that the electrode 32 is embedded in the ceramic material. An electrical via 34 is formed through the surface 30 as described above, connecting to the electrode 32. In this embodiment, the electrode 32 is completely encased within the ceramic material, but electrical connection is achieved using the via 34. The via 34 can be created in step 16 prior to co-firing, or in step 18 after co-firing.

In FIG. 2, the electrodes 24a, 24b, 28, 32 can be used together, separate from one another or in any combinations. In addition, the electrodes 24a, 24b, 28, 32 are not limited to being linear and can take on other configurations. In addition, electrical connection can be established using wires, direct exposure of an electrode surface, by vias, or by combinations thereof.

FIG. 3 illustrates a disk-shaped transducer 40 that comprises a monolithic body 42 formed by the process described above. The monolithic body 42 is formed by a ceramic material, and at least one electrode (shown in broken lines) is embedded in and substantially encased by the ceramic material. This example illustrates two circumferential electrodes 44a, 44b completely embedded within the ceramic material. Each electrode 44a, 44b is completely and entirely encased within the ceramic material so that no portion of either electrode 44a, 44b is directly physically exposed to the surrounding environment. Instead, electrical connection can be established using wires, vias, capacitive coupling, inductive coupling, or other means as described above.

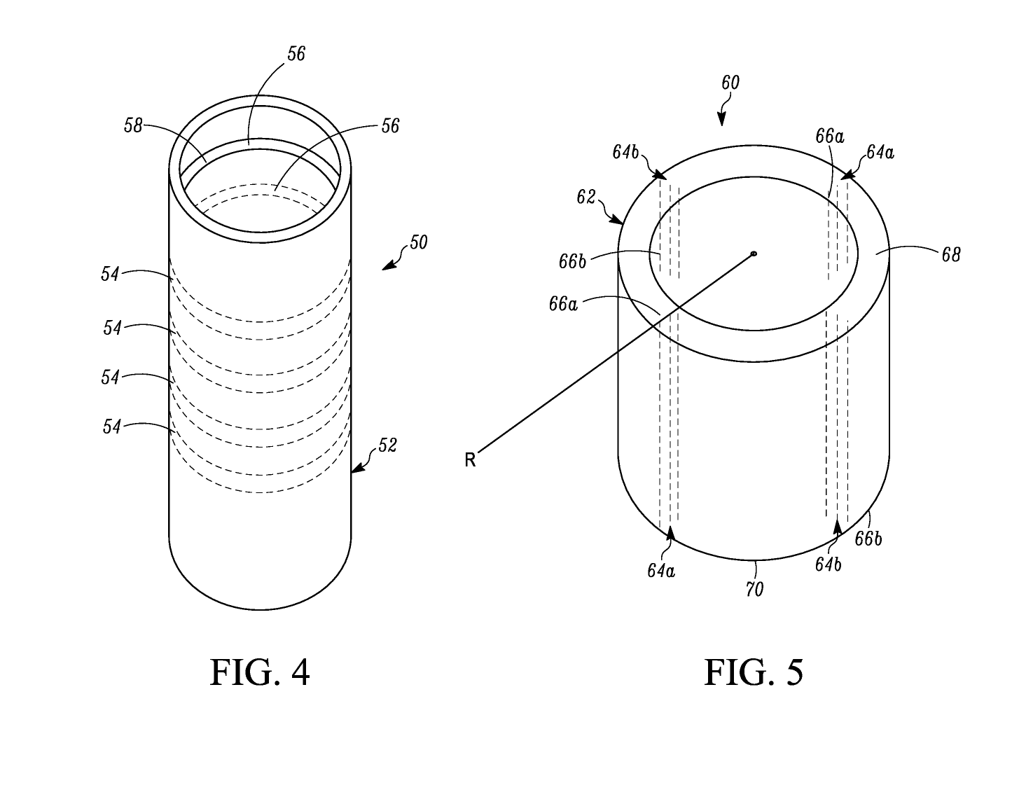

FIG. 4 illustrates a cylindrical transducer 50 that comprises a monolithic body 52 formed by the process described above. The monolithic body 52 is formed by a ceramic material, and at least one electrode (shown in broken lines) is embedded in and substantially encased by the ceramic material. This example illustrates a plurality of outer circumferential electrodes 54 completely embedded within the ceramic material and a plurality of inner circumferential electrodes 56. The electrodes 54 are referred to as outer because they are embedded in the ceramic material at a radially outer position relative to the electrodes 56. The outer electrodes 54 are axially or longitudinally spaced from one another along the length of the body 52. In the illustrated example, each of the outer electrodes 54 is completely and entirely encased within the ceramic material so that no portion of any of the electrodes 54 is directly physically exposed to the surrounding environment. Instead, electrical connection can be established using wires, vias, capacitive coupling, inductive coupling, or other means as described above. The inner electrodes 56 can be embedded in the ceramic material but have some or all of their radially inner facing surfaces 58 exposed for electrical connection as shown in solid lines in FIG. 4. Alternatively, the inner electrodes 56 can be completely and entirely encased within the ceramic material so that no portion of any of the electrodes 56 is directly physically exposed to the surrounding environment as shown in broken lines in FIG. 4.

FIG. 5 illustrates a ring-shaped transducer 60 that comprises a monolithic body 62 formed by the process described above. The monolithic body 62 is formed by a ceramic material, and at least one electrode (shown in broken lines) is embedded in and substantially encased by the ceramic material. This example illustrates a plurality of axially/longitudinally extending electrodes 64a, 64b substantially embedded within and encased by the ceramic material. The electrodes 64a, 64b are also radially extending along a radius R of the body 62. In the illustrated example, the radially opposite electrodes 64a have ends 66a that extend to, and are externally exposed at, a first surface 68 of the ring-shaped body 62 for electrical connection but do not extend to and are not externally exposed at a second surface 70 opposite the first surface 68. The radially opposite electrodes 64b have ends 66b that extend to and are externally exposed at the second surface 70 of the ring-shaped body 62 for electrical connection but do not extend to and are not externally exposed at the first surface 68.

The examples and features discussed above with respect to FIGS. 1-5 can be used separately or together in any combinations thereof. In addition, many other configurations of monolithic transducer bodies, and configurations and orientations of electrodes, can be produced and are intended to be encompassed herein.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A process of forming a monolithic transducer, comprising:
embedding at least one electrode in an un-fired ceramic material; and
co-firing the ceramic material and the at least one electrode to produce a monolithic body that forms the monolithic transducer.

2. The process of claim 1, further comprising prior to co-firing, embedding at least one additional electrode in the un-fired ceramic material;
co-firing includes co-firing the ceramic material, the at least one electrode, and the at least one additional electrode; and
exposing the at least one electrode and/or the at least one additional electrode outside the ceramic material for electrical connection.

3. The process of claim 2, wherein exposing the at least one electrode and/or the at least one additional electrode outside the ceramic material occurs prior to co-firing.

4. The process of claim 2, wherein exposing the at least one electrode and/or the at least one additional electrode outside the ceramic material occurs after co-firing.

5. The process of claim 1, wherein embedding the at least one electrode in the un-fired ceramic material comprising embedding the at least one electrode so that the at least one electrode is substantially encased by the un-fired ceramic material.

6. The process of claim 1, wherein the at least one electrode and the un-fired ceramic material are arranged together prior to co-firing by additive manufacturing.

7. The process of claim 1, wherein the at least one electrode is formed by additive manufacturing, and the un-fired ceramic material is formed by additive manufacturing.

8. The process of claim 1, wherein the monolithic transducer forms a hydrophone or an underwater acoustic projector.

9. A monolithic transducer formed by the process of claim 1.

10. The monolithic transducer of claim 9, further comprising at least one additional electrode embedded in the ceramic material and substantially encased by the ceramic material, and the at least one electrode and/or the at least one additional electrode are exposed outside the ceramic material for electrical connection.

11. The monolithic transducer of claim 10, wherein the monolithic body consists essentially of the ceramic material, the at least one electrode, and the at least one additional electrode.

12. The monolithic transducer of claim 10, wherein the monolithic body consists of the ceramic material, the at least one electrode, and the at least one additional electrode.

13. The monolithic transducer of claim 9, wherein the monolithic body is in the shape of a plate, a disk, a cylinder or a ring.

14. A microphone that includes the monolithic transducer of claim 9.

15. The microphone of claim 14, wherein the microphone is a hydrophone.

16. An acoustic projector that includes the monolithic transducer of claim 9.

17. The acoustic projector of claim 16, wherein the acoustic projector is an underwater acoustic projector.
